(19) United States
(12) Patent Application Publication
(10) Pub. No.: US 2008/0309962 A1
(43) Pub. Date: Dec. 18, 2008

(54) SYSTEM AND METHOD FOR CONTENT-BASED ALTERNATE IMAGING

(75) Inventor: Mark A. Smith, Rochester, NY (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION, Stamford, CT (US)

(21) Appl. No.: 11/761,618

(22) Filed: Jun. 12, 2007

(51) Int. Cl. G06F 15/00

(52) U.S. Cl. 358/1.15; 358/1.4

(57) ABSTRACT

Printing systems and methods are presented for front end processing of an incoming print job in a printing system, in which a single raster image processor instance creates ripped objects from incoming page description language files and one of two or more imagers is selectively activated according to incoming print job logical page content to create raster page images for ripped objects associated with a given logical page of the incoming print job. The imager selection can be made according to cost considerations and color printing capabilities to economize the usage of a higher cost print engine associated with a first imager while ensuring that the imager is associated with a print engine having the capabilities required for the content of the given logical page. In this manner, individual logical pages can be imaged in a single digital front end by a monochrome imager if possible, and other logical pages are imaged by a color imager where needed or where the color requirements cannot be discerned by evaluating the incoming job content. The selection of the imager can also be based on other factors, such as job programming associated with the incoming print job, site policies, image assembly considerations, and sheet ordering considerations.

### BACKGROUND

Commercial printing systems generally include a digital front end (DFE) that processes incoming print jobs in the form of page description language (PDL) files to create print-ready images, as well as a print engine that receives the images and prints these onto paper or other printable media. Currently, it is cheaper and faster to print a monochrome sheet on a monochrome print engine than it is to print that same monochrome sheet on a color print engine. It is therefore sometimes desirable to direct monochrome sheets from a given job to a monochrome print system with color sheets being sent to a different color system. In one example, current practice includes splitting an incoming job into two page description language files, such as PDFs, one for mono printing, one for color printing. Each of the PDFs is then treated is a separate print job and processed by separate RIPping and imaging components of two different DFEs. The separation of the incoming print job is conventionally performed through execution of a software “splitter” filter that operates on the page description language file associated with the incoming job. The splitter identifies monochrome content and creates a new pdl for the monochrome pages of the job, and creates a second new pdl file for the color page content. The mono pdl file is submitted to the monochrome printing system to be printed while the color pdl file is submitted to a color printing system.

This approach, however, has notable limitations and problems. In particular, the “color splitter” approach requires two independent DFEs and two independent print stations to operate on the two pdl files created by the splitter, and the printer operator must perform manual operations to ensure that the job is ordered and finished as required. Conventional splitter software, moreover, is typically limited to use with only one type of pdl file (e.g., PDF files). Also, the “color splitter” approach creates two new pdl files, which are then executed by two completely independent RIP instances. These RIP instances do not share internal state information and may therefore lead to job integrity issues. Furthermore, this technique does not take into account imposition and other image assembly operations that may influence the ultimate colorization of an assembled sheet side, which often causes incorrect splitting. In addition, the current software splitting technique does not account for queue-level, job-level, or page-level programming that may influence the ultimate colorization of a page image. Thus, there remains a need for improved printing systems and methods by which print jobs can be economically processed by a single DFE for submission of individual color and monochrome images to monochrome and color print engines in a single printing system.

### BRIEF DESCRIPTION

Methods and systems are provided for content-based alternate imaging in which a single DFE image path includes a raster image processor instance coupled to multiple imaging components (imagers). The DFE may include a plurality of RIP instances, each being operatively coupled with corresponding imagers. The imagers are individually associated with corresponding print engines having different capabilities, such as a color imager providing color page images for consumption by a color print engine, and a monochrome imager creating monochrome images for a monochrome print engine. The present disclosure thus associates a single RIP instance with multiple imagers, and may advantageously provide a content separation component, such as a software module or other logic that controls the operation of the multiple imagers by selectively activating one of the imagers for each logical page of an incoming print job. This disclosure therefore advantageously facilitates consistent RIP settings and resources to be used for all pages of an incoming print job that requires mixed marking (e.g. color and monochrome) capabilities. Compared with conventional software splitting techniques described above, the disclosure can be employed to avoid or mitigate the need for multiple DFE's and print stations and related manual assembly of output to preserve job integrity, while supporting multiple page description language formats. Moreover, the disclosure is able to account for image assembly operations that may ultimately affect colorization of an assembled sheet side, along with effects of queue/job/page programming in addition to page content.

One or more aspects of the present disclosure relate to a printing system and a digital front end (DFE) therefor comprised of a raster image processor (RIP) which receives incoming print jobs from a host or other source, where the print jobs include multiple logical pages in a page description language. The RIP component provides ripped objects to an object collector that is coupled with first and second imagers which create raster page images from ripped objects. A content separation component selectively activates a single one of the imagers to create raster page images for ripped objects associated with a given logical page of the incoming print job. In some possible embodiments, the content separation may be done according to the content of the logical page according to one or more criteria, such as whether or not a given logical page can be processed using a low cost (e.g., monochrome) print engine or whether a higher cost (e.g., color) print engine is required for printing the content of the logical page. The selective activation of one of the imagers may also be based at least partially on one or more of job programming associated with the incoming print job, site policies, image assembly considerations, and sheet ordering considerations.

Other aspects of the present disclosure provide a method for front end processing of an incoming print job in a printing system, in which a print job is received that includes a plurality of logical pages in a page description language. The method involves determining the content of the logical pages of the incoming print job, performing raster image processing to provide ripped objects for the logical pages of the incoming print job, and storing the ripped objects into an object collector. Raster page images are selectively created from the ripped objects for a given logical page of the incoming print job using a single one of a first imager and a second imager where the imager selection is based at least in part on the determined content of the given logical page. The content determination in one example includes determining whether the given logical page can be printed using a monochrome print engine, wherein the raster page images are created by activating the second imager to create raster page images for the given logical page if the given logical page can be printed using a monochrome print engine, and otherwise activating the first imager. In other implementations, the content is scrutinized to ascertain whether the given logical page can be printed using a low cost print engine, and if so, using the associated imager.

### BRIEF DESCRIPTION OF THE DRAWINGS

The present subject matter may take form in various components and arrangements of components, and in various steps and arrangements of steps. The drawings are only for purposes of illustrating preferred embodiments and are not to be construed as limiting the subject matter.

FIG. 1 is a system diagram illustrating an exemplary printing system with a digital front end having a single raster image processing component instance along with a plurality of imagers and a content separation component to selectively enable one of the imagers for processing individual logical pages of an incoming print job according to the present disclosure;

FIG. 2 is a flow diagram illustrating an exemplary method for front end processing of an incoming print job according to the present disclosure; and

FIG. 3 is a flow diagram illustrating another exemplary method for front end processing of an incoming print job according to the present disclosure.

### DETAILED DESCRIPTION

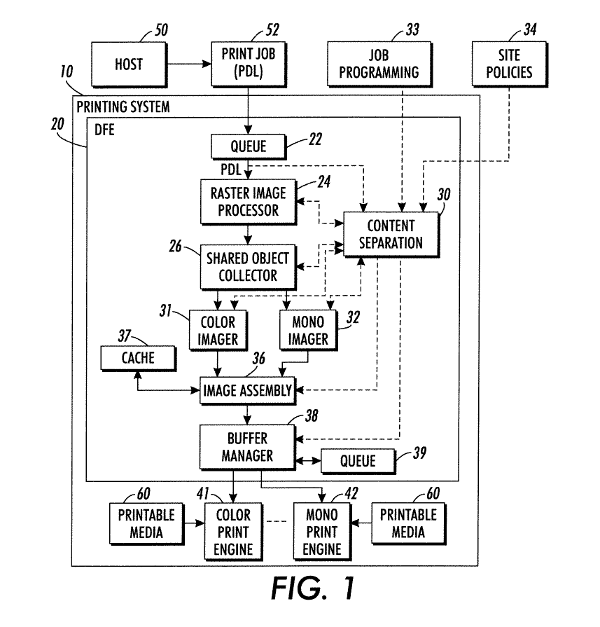

Referring now to the drawings, FIG. 1 illustrates a printing system 10 in accordance with one or more aspects of the present disclosure, comprising a digital front end (DFE) 20 with a single raster image processor instance 24 and a plurality of imagers 31, 32 operatively associated with corresponding print engines 41, 42 that print images on a printable media 60 introduced thereto. The DFE 20 may include additional RIP instances (not shown), such as a PostScript RIP, and PCL RIP, etc., wherein each RIP instance is operatively coupled with corresponding multiple imagers. Furthermore, a single print job may be processed by two or more RIP instances of the same type (e.g., page parallel RIP). The print engines 41, 42 may all be under the control of a common control system for printing images from a common print job stream, although not a requirement of the disclosure. In the example of FIG. 1 two imagers 31 and 32 are provided in the DFE 20 corresponding to a color print engine 41 and a monochrome print engine 42, respectively, although any number of imagers and print engines may be provided in accordance with the disclosure. Moreover, the imagers 31 and 32 in the exemplary system 10 are monochrome and color, respectively, although the present disclosure is not limited to this specific combination, wherein any number, type, and combination of multiple imagers 31, 32 and associated print engines 41, 42 may be employed in implementing the various aspects and features of the disclosure. In another possible implementation, for example, two or more color imagers could be provided with a single RIP component instance 24 in a DFE 20, where one of the imagers is associated with a print engine having a lower print cost than a print engine associated with the other imager. Still another possible example includes two or more monochrome imagers associated with print engines having different associated print costs. The printing system 10, moreover, can have a modular architecture that allows one or more print engines 41, 42 to be interchanged with other print engines, wherein some engines 41 may be adapted to produce color printed images while others 42 may be limited to monochrome imaging. The imagers 31, 32 are selectively activated and deactivated by a content separation component 30 to operate on ripped objects from the shared collector 26 in order to provide color and monochrome page images to an assembly component 36 having a cache 37. The DFE 20 includes a buffer manager component 38 with a queue 39 that provides assembled images from the image assembly component 36 to selected print engines 41, 42.

The print engines 41, 42 may be any device or marking apparatus for applying an image from the DFE 20 to printable media (print media) 60 such as a physical sheet of paper, plastic, or other suitable physical media substrate for images, whether precut or web fed. The print engines 41, 42 generally include hardware elements employed in the creation of desired images by electrophotographic processes wherein suitable print engines 41, 42 may also include ink-jet printers, such as solid ink printers, thermal head printers that are used in conjunction with heat sensitive paper, and other devices capable of printing an image on a printable media 60. It is to be appreciated that each of the print engines 41, 42 can include an input/output interface, memory, a print cartridge platform, a print driver, a function switch, a controller and a self-diagnostic unit, all of which can be interconnected by a data/control bus, and that the individual print engines 41, 42 can have a different processing speed capability. Another embodiment of printing system 10 enables custom color, process color, and/or black and white printing on the same sheet in a single printing system where a single DFE 20 provides for raster image processing (RIPping), imposition, annotation, print marks, and compression with assembled sheet side images being provided to suitable print engines 41 and 42 for a given incoming print job 52.

The DFE 20 as well as the collector 26, imagers 31, 32, the content separation component 30, the assembly component 36, 37, and the buffer manager 38, 39 thereof, can be any suitable hardware, software, or combinations thereof, whether a unitary system or a plurality of systems implementing the front end functionality in distributed form to provide an interface between submitting hosts 50 providing incoming print jobs 52 and the print engines 41, 42. The printing system 10 can be any form of commercial printing apparatus, copier, printer, facsimile machine, or other system having two or more print engines 41, 42 by which visual images, graphics, text, etc. are printed on a page or other printable medium 60, including xerographic, electro photographic, and other types of printing technology, wherein such components are not specifically illustrated to avoid obscuring the various alternate imaging features of the present disclosure. The DFE 20 in FIG. 1 includes a queue 22 having various hardware memory, disk drives, or other storage apparatus by which one or more incoming print jobs 52 can be received from a computer or other host 50 and stored, in whole or in part, for processing by a raster imaging processor (RIP) component instance or system 24. The RIP component instance 24 operates in concert with the queue 22 to process incoming print jobs 52 to thereby create RIPped objects which are stored in a shared object collector 26 of the DFE 20. Once all of the objects for a given logical page have been collected, an activated imager 31 or 32 converts the ripped objects into a page image of a given resolution, bit depth, and number of color planes.

In operation according to the present disclosure, ripped objects from the shared collector 26 are received by a selected one of the imagers 31 and 32 for creation of raster page images that are provided to the image assembly component 36, 37. The exemplary content separation component 30 may include any suitable hardware, logic, software, or combinations thereof which are configured, programmed, or otherwise adapted to implement the selective imager activation and other functions set forth herein, wherein the separation component 30 in the illustrated printing system 10 of FIG. 1 is integrated into the DFE 20, although not a strict requirement of the present disclosure. The content separation component 30 operates to evaluate the content of the pdl job files received in the queue 22 and selectively activates a single one of the imagers 31 or 32 to create raster page images for ripped objects associated with each logical page of an incoming print job. In one example, the separation component 30 selectively activates one of the imagers based at least partially on whether the given logical page can be printed with a monochrome print engine, and in another example, the activated imager is selected based on print costs associated with the print engines 41, 42 based on the print job content for a given logical page. The content separation component 30, moreover, may receive job programming information 33, and may also consider site policies 34 (e.g. both sides of a sheet must be Imaged using the same imager, or other policies), wherein the selective activation of one of the imagers 31, 32 may also be based at least partially on job programming 33 associated with the incoming print job, one or more site policies 34, image assembly considerations with respect to the image assembly component 36, and/or sheet ordering considerations.

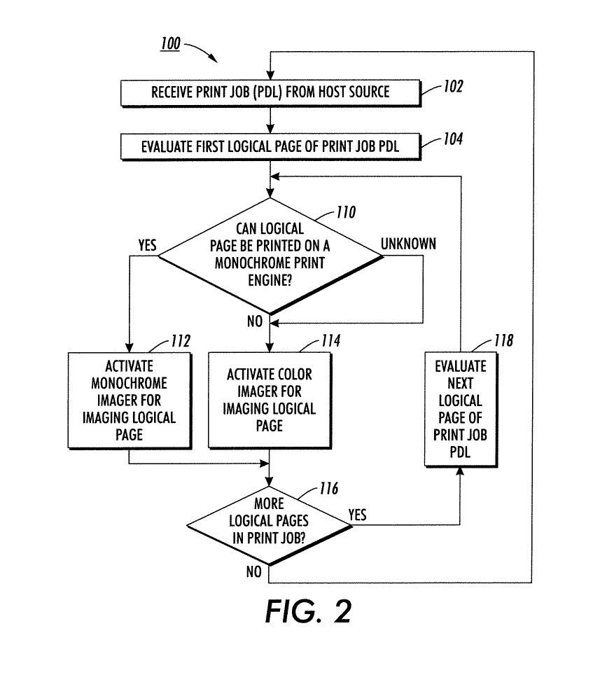

In the illustrated example where the first imager 31 is a color imager and the second imager 32 is a monochrome imager, the content separation component 30 attempts to determine from the PDL whether a given logical page of the incoming print job 52 can be printed with the monochrome print engine 42. If so, the separation component 30 selectively activates the second imager 32. Otherwise, if the given logical page cannot be printed with a monochrome print engine or if the content separation component cannot determine whether the given logical page can be printed with a monochrome print engine, the separation component 30 selectively activates the color imager 31, as illustrated and described further below with respect to FIG. 2.

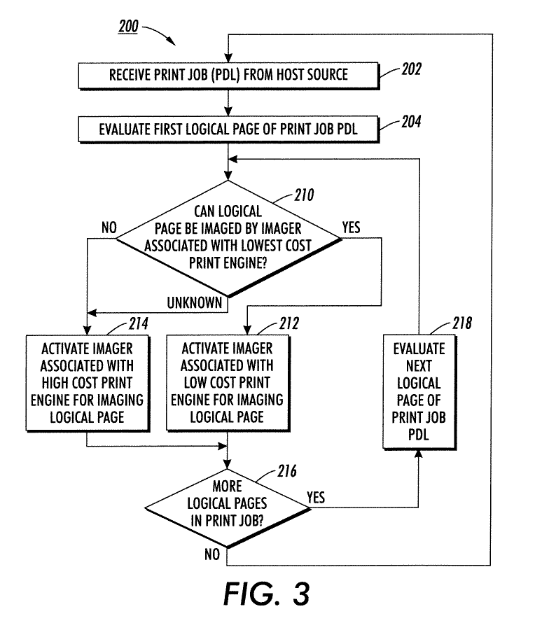

In another possible embodiment, the content separation component 30 determines which one of the imagers 31 or 32 to activate for a given logical page based at least partially on print costs associated with the corresponding print engines 41 and 42, as shown in FIG. 3 below. The content separation component, moreover, may also take into account other factors, including but not limited to job programming 33 associated with the incoming print job, site policies 34, image assembly considerations, and sheet ordering considerations in selecting one of the imagers 31 or 32 for a given logical page of the incoming print job 52.

In this regard, it is noted that for cases in which the ultimate imaging will depend on the content of the page, the logical page in this embodiment is speculatively imaged as color. In this implementation, moreover, the separation component 30 makes its determination known to both imagers 31 and 32 and activates only one imager, with the other imager remaining inactive or deactivated for the duration of the given logical page. Furthermore, the active imager 31 or 32 may interact with the raster image processor 24 so that the RIP produces optimized objects that are targeted to the resolution of the active imager. When all objects for the page have been completed, the active imager 31 or 32 produces a raster page image. In the illustrated example, if the color imager 31 has been speculatively employed to image a page with unknown or indeterminate content, the color imager 31 then attempts to discern whether or not there is any content in the CMY color planes. If not, the page image is actually monochrome, and the color imager 31 may inform the separation component 30 of this situation, where the separation component 30 may in turn invoke a function to convert the color image into monochrome at the required resolution, which may involve halftoning based on pixel Tags associated with the color image. In another possible implementation, the separation component 30 may instead activate the monochrome imager 32 to produce a monochrome raster image directly from the collected page objects. In both these examples, the separation component 30 may then cause the color image to be deleted, whereby a single page image (color or monochrome) is provided to the assembly component 36. Thereafter, the ripped objects in the collector for the imaged logical page may be deleted, and the RIP begins processing the next logical page.

The exemplary DFE 20 thus provides an image path including a single RIP instance coupled to multiple imaging software components 31, 32 where each is associated with a marking device or print engine 41, 42 with different capabilities, and also with potentially different print costs, by which consistent RIP settings and resources may be employed for all pages of incoming print jobs 52 that require mixed marking capabilities, and the system 10 may be used for multiple pdl formats. This novel approach advantageously mitigates or avoids the need for multiple DFEs and print stations and the associated manual assembly of output to preserve job integrity, while accommodating assembly operations that may ultimately affect colorization of an assembled sheet side, and queue/job/page programming effects, as well as page content. As each logical page is RIPped, the content separation component 30 determines whether to image the logical page using the color imager 31 or the monochrome imager 32 based on a combination of job programming, sheet layout and page content considerations. Once a logical page image has been imaged, it proceeds through image assembly into sheet side images in the component 36 including imposition, annotation, variable data, etc., and the resulting sheet side images are buffered by the manager component 38. Once the buffered job is to be printed, the sheet side images are directed to either the color print engine 41 or the monochrome print engine 42, wherein the various aspects of the disclosure may be employed whether or not the print engines 41 and 42 share a common paper path or are completely independent. In this regard, the exemplary system 10 and other systems employing the aspects of this disclosure can effectively combine monochrome and color image paths such that a single DFE image path can accommodate monochrome and color artifacts with equal facility.

In cases where an applicable site policy 34 provides that both sheet side images are to be constructed using the same imager 31 or 32, then the content separation component 30 may accordingly image the front side as color where the corresponding back side includes color content, even where the front has no color content, and vice versa. Likewise, where such a rule is in place, the fact that one side requires the capabilities of a higher cost imager/print engine could cause the other side to be imaged using the corresponding high cost imager regardless of whether the higher cost capabilities are required for both sides of a sheet. Moreover, for pdl types (e.g., PDFs) where the logical page content can accurately be ascertained prior to RIP, the content separation component 30 uses this information for both sheet sides. In addition, in such policy situations, the separation component 30 preferably causes the objects for both sheet sides to be retained in the shared object collector 26 until the content of both sides can be reliably determined, after which both sheet sides are imaged using the selected imager 31 or 32 accordingly. The novel DFE 20, moreover, may advantageously convert a monochrome front side image into contone “color” in such cases. With respect to imposition layout requirements, if multiple page images are to be assembled on a single sheet side, the presence of a single color page image would cause the separation component 30 to activate the color imager 31 for all of the page images.

In certain customer applications where monochrome images printed by a color engine (such as when these images share the same imposed sheet side as color page images) would be unacceptably different from an image quality perspective than monochrome images, then the following extension is proposed: Each imager will produce either color or mono page images as before. However, the Image Assembly component will produce 2 sheet side images instead of 1. The first sheet side image will contain only assembled color page images. The second will contain only assembled monochrome page images. During the course of printing, both color and monochrome engines will mark the same physical sheet side, but using the requisite sheet side image for the engine. In this way, productivity of the print system can be traded off for consistent monochrome image quality.

Referring also to FIGS. 2 and 3, methods 100 and 200 are illustrated for front end processing of an incoming print job in accordance with the present disclosure. While the exemplary methods 100 and 200 are illustrated and described below in the form of a series of acts or events, it will be appreciated that the various methods of the disclosure are not limited by the illustrated ordering of such acts or events except as specifically set forth herein. In this regard, except as specifically provided hereinafter, some acts or events may occur in different order and/or concurrently with other acts or events apart from those illustrated and described herein, and not all illustrated steps may be required to implement a process or method in accordance with the present disclosure. The illustrated methods 100 and 200 and other methods of the disclosure may be implemented in hardware, software, or combinations thereof, in order to provide front end processing using a single RIP component instance and multiple imagers for a given print job in any form of printing system such as those illustrated and described above, wherein the disclosure is not limited to the specific applications and implementations illustrated and described herein.

Referring initially to FIG. 2, the method 100 begins with receipt of a print job at 102, such as job 52 received in FIG. 1 above from a host computer or other source of incoming print jobs 50. The received print job may be of any suitable form, for instance, a page description language (PDL) file, as well as an optional job ticket with attributes to be applied to the job when printed. Raster image processing is performed (not shown) to provide ripped objects for logical pages of the incoming print job. An evaluation is performed at 104 with respect to content, any applicable job programming, site policies, etc., for a first logical page of the print job, where the evaluation may be performed by any suitable digital front end component such as the exemplary content separation logic component 30 described above with respect to FIG. 1.

A determination is made at 110 as to whether the current logical page can be printed using a monochrome print engine (e.g. print engine 42 in FIG. 1). The determination at 110 may also take into account the same issue with respect to a number of logical pages to be printed on the same sheet or sheet side according to any applicable site policies, wherein such a determination at 110 would answer whether all such logical pages can be printed with a monochrome print engine. In the situation of a single logical page at 110, if the page indeed can be printed with a monochrome engine (YES at 110), the monochrome imager (e.g. monochrome imager 32 in FIG. 1 above) is activated at 112 to image the logical page using ripped objects for that page. Otherwise (NO or UNKNOWN at 110), the color imager (e.g. imager 31 in FIG. 1) is activated at 114. Once the current logical page has been imaged at 112 or 114, a determination is made at 116 as to whether there are further logical pages to be processed for the incoming job, and if so (YES at 116), the next logical page is evaluated at 118. This process repeats at 110-116 as described above for remaining logical pages until all the logical pages have been processed (NO at 116), after which the process 100 returns to receive the next incoming print job at 102.

FIG. 3 illustrates another exemplary method 200 for performing front end processing of an incoming print job in accordance with the present disclosure, in which one of two or more imagers is selected for imaging a logical print job page based at least in part on print cost considerations. A print job is received at 202, and raster image processing is performed to provide ripped objects for logical pages of the job. At 204, the content of a first logical page is evaluated, where the evaluation may also take into account other factors such as applicable job programming, site policies, etc. At 210, a determination is made as to whether the current logical page can be printed using a lowest cost print engine. If so (YES at 210), the imager associated with the low cost print engine is activated for the current logical page at 212 to image the logical page using ripped objects for that page. If the low cost imager/print engine cannot accommodate the content requirements of the logical page, or if the determination cannot be made (NO or UNKNOWN at 210), the imager associated with the high cost print engine is activated 214. In either case, a determination is thereafter made at 216 as to whether there are further logical pages to be processed for the incoming job. If so (YES at 216), the next logical page is evaluated at 218, and the process repeats at 210-216 for any remaining logical pages. Once all the logical pages have been processed for the incoming print job (NO at 216), the process 200 returns to receive the next incoming print job at 202.

The above examples are merely illustrative of several possible embodiments of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several embodiments, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”. It will be appreciated that various of the above-disclosed and other features and functions, or alternatives thereof, may be desirably combined into many other different systems or applications, and further that various presently unforeseen or unanticipated alternatives, modifications, variations or improvements therein may be subsequently made by those skilled in the art which are also intended to be encompassed by the following claims.

1. A printing system, comprising:
a raster image processor operative to receive an incoming print job that includes a plurality of logical pages in a page description language and to provide ripped objects to an object collector;
first and second imagers coupled with the object collector and operative to create raster page images from ripped objects; and
a content separation component operatively coupled with the imagers to selectively activate a single one of the imagers to create raster page images for ripped objects associated with a given logical page of the incoming print job.

2. The printing system of claim 1, wherein the content separation component selectively activates one of the imagers based at least partially on whether the given logical page can be printed with a monochrome print engine.

3. The printing system of claim 2, wherein the selective activation of one of the imagers by the content separation component is also based at least partially on one of job programming associated with the incoming print job, site policies, image assembly considerations, and sheet ordering considerations.

4. The printing system of claim 2, wherein the first imager is a color imager and the second imager is a monochrome imager, wherein the content separation component attempts to determine from the page description language whether the given logical page can be printed with a monochrome print engine, and wherein the content separation component is operative to selectively activate the second imager if it determines that the given logical page can be printed with a monochrome print engine and to selectively activate the first imager if the given logical page cannot be printed with a monochrome print engine or if the content separation component cannot determine whether the given logical page can be printed with a monochrome print engine.

5. The printing system of claim 1, wherein the first imager is operatively associated with a first print engine and the second imager is operatively associated with a second print engine, and wherein the content separation component determines which one of the imagers to activate for the given logical page based at least partially on print costs associated with the first and second print engines.

6. The printing system of claim 5, wherein the selective activation of one of the imagers by the content separation component is also based at least partially on one of job programming associated with the incoming print job, site policies, image assembly considerations, and sheet ordering considerations.

7. The printing system of claim 5, wherein a print cost of the first print engine is higher than a print cost of the second print engine, and wherein the content separation component attempts to determine from the page description language whether the given logical page can be printed with the second print engine, and wherein the content separation component is operative to selectively activate the second imager if it determines that the given logical page can be printed with the second print engine and to selectively activate the first imager if it determines that the given logical page cannot be printed with the second print engine or if the content separation component cannot determine whether the given logical page can be printed with the second print engine.

8. The printing system of claim 7, wherein the first imager is a color imager and the second imager is a monochrome imager.

9. The printing system of claim 5, wherein the content separation component selectively activates one of the imagers based at least partially on whether the given logical page can be printed with a monochrome print engine.

10. The printing system of claim 9, wherein the first imager is a color imager and the second imager is a monochrome imager, wherein the content separation component attempts to determine from the page description language whether the given logical page can be printed with a monochrome print engine, and wherein the content separation component is operative to selectively activate the second imager if it determines that the given logical page can be printed with a monochrome print engine and to selectively activate the first imager if the given logical page cannot be printed with a monochrome print engine or if the content separation component cannot determine whether the given logical page can be printed with a monochrome print engine.

11. A digital front end for a printing system, the digital front end comprising:
a single raster image processor instance operative to receive an incoming print job that includes a plurality of logical pages in a page description language and to provide ripped objects to an object collector;
a color imager coupled with the object collector and operative to create raster page images from ripped objects;
a monochrome imager coupled with the object collector and operative to create raster page images from ripped objects;
an image assembly component operatively coupled with the imagers to create assembled sheet side images from the raster page images and to selectively provide raster page images from the color imager to a color print engine and raster page images from the monochrome imager to a monochrome print engine; and
a content separation component operatively coupled with the raster image processor, the imagers, and the image assembly component, and operative to selectively activate a single one of the imagers to create images for ripped objects associated with a given logical page of the incoming print job based at least in part on whether the given logical page can be printed using the monochrome print engine.

12. The digital front end of claim 11, wherein the selective activation of one of the imagers by the content separation component is also based at least partially on one of job programming associated with the incoming print job, site policies, image assembly considerations, and sheet ordering considerations.

13. The digital front end of claim 11, wherein the content separation component attempts to determine from the page description language whether the given logical page can be printed using the monochrome print engine, and wherein the content separation component is operative to selectively activate the monochrome imager if it determines that the given logical page can be printed using the monochrome print engine and to selectively activate the color imager if the given logical page cannot be printed using the monochrome print engine or if the content separation component cannot determine whether the given logical page can be printed using the monochrome print engine.

14. The digital front end of claim 13, wherein the selective activation of one of the imagers by the content separation component is also based at least partially on one of job programming associated with the incoming print job, site policies, image assembly considerations, and sheet ordering considerations.

15. A method for front end processing of an incoming print job in a printing system, the method comprising in optional sequence:
receiving a print job having a plurality of logical pages in a page description language;
determining the content of the logical pages of the incoming print job;
performing raster image processing to provide ripped objects for the logical pages of the incoming print job;
storing the ripped objects into an object collector;
selectively creating raster page images from the ripped objects for a given logical page of the incoming print job using a single one of a first imager and a second imager based at least in part on the determined content of the given logical page.

16. The method of claim 15, wherein determining the content of the logical pages comprises determining whether the given logical page can be printed using a monochrome print engine.

17. The method of claim 16, wherein selectively creating raster page images comprises:
activating the second imager to create raster page images for the given logical page if the given logical page can be printed using a monochrome print engine; and
activating the first imager to create raster page images for the given logical page if the given logical page cannot be printed using a monochrome print engine or if no determination is made as to whether the given logical page can be printed using a monochrome print engine.

18. The method of claim 15, wherein a print cost of a first print engine associated with the first imager is higher than a print cost of a second print engine associated with the second imager, wherein determining the content of the logical pages comprises determining whether the given logical page can be printed using the second print engine, and wherein selectively creating raster page images comprises:
activating the second imager to create raster page images for the given logical page if the given logical page can be printed using the second print engine; and
activating the first imager to create raster page images for the given logical page if the given logical page cannot be printed using the second print engine or if no determination is made as to whether the given logical page can be printed using the second print engine.

20. The method of claim 15, wherein selectively creating raster page images for the given logical page using a single one of the first and second imagers is based at least partially on one of job programming associated with the incoming print job, site policies, image assembly considerations, and sheet ordering considerations.
